(19) United States
(12) Patent Application Publication
(10) Pub. No.: US 2020/0014467 A1
(43) Pub. Date: Jan. 9, 2020

(54) VISIBLE LIGHT COMMUNICATION (VLC) OPTICAL RECEIVER

(71) Applicant: Terra Phoenix Sdn. Bhd., Cyberjaya (MY)

(72) Inventors: Ching Seong Tan, Selangor (MY); Thoong Hoy Yap, Selangor (MY); Mhd Kenan Zeibak, Selangor (MY); Lee Nee See, Selangor (MY)

(21) Appl. No.: 16/503,955

(22) Filed: Jul. 5, 2019

(30) Foreign Application Priority Data
Jul. 6, 2018 (MY) MYPI2018001266

(51) Int. Cl. H04B 10/67; H04B 10/50; G02B 3/08

(52) U.S. Cl. CPC H04B 10/672; G02B 3/08; H04B 10/502

(57) ABSTRACT

A visible light communication (VLC) optical receiver (100) is provided, the receiver (100) includes a photodetector; and a modified Fresnel lens (103), characterised in that the lens (103) is curved into a convex shape such that multiple focal points (110) are created when light from a light source is diffracted through the lens (103) allowing the light signal to be received by the photodetector at the different positions of the photodetector corresponding to said focal points.

### FIELD OF INVENTION

The invention relates to a visible light communication (VLC) optical receiver and a modified Fresnel lens used therewith.

### BACKGROUND

FIG. 1(a) shows a block diagram depicting system architecture of a visible light communication (VLC) transmitter and receiver. A VLC system typically includes a transmitter and receiver circuit together with LED and photodetector to send and receive data via optical links. Optionally, an additional Wi-Fi link can be added as a backup to send and receive data if the optical link becomes unavailable.

FIG. 2 shows a lens paired with a photodiode that is connected to a receiver circuit as seen in existing VLC systems, wherein the lens increases light intensity in order to be received by the photodiode. This increased light intensity translates to increased power density received by the photodiode and the receiver circuit which further enhances the signal to noise ratio (SNR) of the received signal. This is due to the lens that converts a wide light beam into a convergent beam with a minimal focal radius.

In current VLC systems, transmitters and receivers typically require line-of-sight (LOS) connection in order to provide high data rate transmission. However, in practical situations there may not always be LOS availability as the receiver's field of view (FOV) may change if it is moved around. If the orientation of the receiver changes, it may not be possible to align the transmitter's field of view with the receiver.

Kim, S M., Baek, M W. & Nahm, (2017) describe use of optical beamforming in a VLC system in order to focus LED light on a target to enhance the signal-to-noise ratio. A spatial light modulator (SLM) is used where a control computer sends a light function to the SLM in order to beamform the light and focus on the optical receivers for multiple devices. However, this document does not address improvement of FOV of a VLC receiver if the transmitter is not aligned with the receiver.

Therefore, there is a need in a VLC system to continuously maintain high speed connectivity within a coverage area by ensuring connectivity between transmitter and receiver even if the FOV changes.

### SUMMARY OF INVENTION

In an aspect of the invention, there is provided a visible light communication (VLC) optical receiver comprising:
a photodetector; and a modified Fresnel lens;
characterised in that the lens is curved into a convex shape such that multiple focal points are created when light from a light source is diffracted through the lens to the photodetector, allowing the light signal to be received by the photodetector at the different positions of the photodetector corresponding to said focal points.

Advantageously, the photodetector may be positioned such that the received power is the highest at an incident plane with the photodetector. Advantageously, this improves the field of view (FOV) of detection of the VLC receiver.

In one embodiment, the light source used is a standard commercial LED and a silicon PIN photodiode is used for its high sensitivity. The light source may also include Laser Diode, Laser, Spatial Light Modulator (SLM) with a backlight or any modulated light source. The photodetector includes a photodiode, array of photodiodes, charge-coupled device (CCD) array, CMOS array, avalanche photodiode (APD) and array of APD detectors that allow detection of high bandwidth optical signals.

Typically, the convex shape provides for multiple focal points being created when light from an LED is diffracted through the lens to the photodiode.

Advantageously, the photodiode can be placed at different locations in order to increase the angles of transmission of light in the VLC receiver as well at varying distance between LED and photodiode.

Advantageously, efficiency of the received power is increased up to a relatively longer distance between an LED and the photodiode compared to efficiency of an unmodified lens.

Advantageously, efficiency of the received power is increased up to a relatively wider angle between an LED and the photodiode compared to efficiency of an unmodified lens.

In a further aspect of the invention there is provided a modified Fresnel lens used within a VLC receiver as described above.

In one embodiment, the modified Fresnel lens is shaped by heating up the lens, or other mechanical means or a combination of both as needed in accordance to a selected container size.

Advantageously, the modified Fresnel lens provides an improved field of view for a VLC receiver over other lenses or when no lenses are used.

In one embodiment, the modified Fresnel lens may be used bidirectionally, to provide multi focal points in a VLC receiver.

### BRIEF DESCRIPTION OF DRAWINGS

It will be convenient to further describe the present invention with respect to the accompanying drawings that illustrate possible arrangements of the invention. Other arrangements of the invention are possible, and consequently the particularity of the accompanying drawings is not to be understood as superseding the generality of the preceding description of the invention.

FIG. 1.a shows a block diagram depicting system architecture of a visible light communication (VLC) transmitter and receiver without a Fresnel lens.

FIG. 1.b shows a block diagram depicting system architecture of a visible light communication (VLC) transmitter and receiver with a Fresnel lens.

FIG. 2 illustrates a convex lens paired with a photodiode that is connected to a receiver circuit as seen in existing VLC systems.

FIG. 3 illustrates a block diagram of a VLC receiver circuit with a modified

Fresnel lens and photodiode connected to a microcontroller and a demodulator.

FIG. 4(a) illustrates a top view of the modified Fresnel lens and (b) illustrates a bottom view of the modified Fresnel lens.

FIG. 5 illustrates front view of the modified Fresnel lens with the reduced diameter.

FIG. 6 illustrates a minimal number of focal points present when a straight Fresnel lens is used.

FIG. 7 illustrates multiple focal points present when a modified Fresnel lens is used.

FIG. 8 illustrates a shaped Fresnel lens that shows the incoming light signal being diffracted into multiple focal points.

FIG. 9 illustrates the various lenses used in the experiments conducted to determine the most efficient Fresnel lens.

FIG. 10 illustrates an experimental setup to determine VLC efficiency at direct line of sight with varying distances.

FIG. 11 illustrates an experimental setup to determine VLC efficiency at various transmission angles between LED and photodiode.

FIG. 12 illustrates an experimental setup to determine VLC efficiency at a different photodiode position (not in direct LOS).

FIG. 13 illustrates an experimental setup to determine VLC efficiency within a coverage area of LED transmission.

FIG. 14 illustrates an experimental setup to determine VLC efficiency of an LED coverage area within a cone radius, R where the photodiode is moved around.

### DETAILED DESCRIPTION

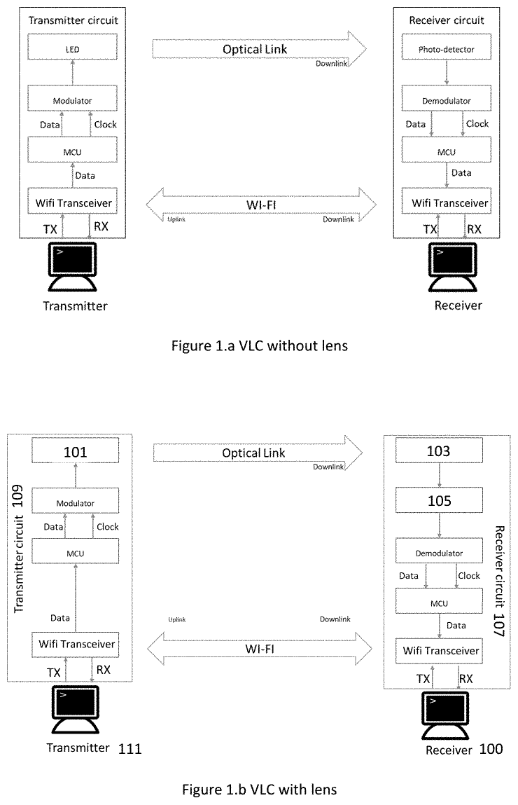

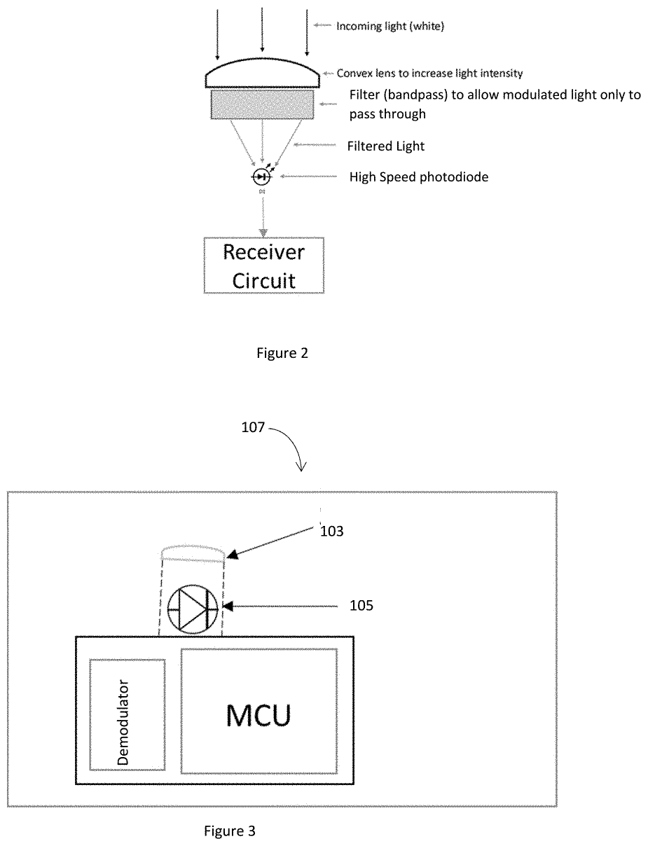

A visible light communication (VLC) optical receiver (100) in use together with a transmitter (111) is described herein as seen in FIG. 1(b). As seen in FIG. 1(a) (without the use of a lens) and FIG. 1(b) (with the use of the Fresnel lens), a VLC system includes a set of transceiver circuits interfaced with a microcontroller (MCU). A transmitter circuit (109) is connected to a modulated light source, and a receiver circuit (107) is connected to a photodetector. In this example as seen in FIG. 1(b), an LED (101) is used as the modulated light source and a photodiode (105) is used as the photodetector. The photodiode (105) senses the incoming light signal from the LED (101) and converts it to an electrical signal and then processes the sent data through the receiver circuit (107). Both WiFi transceivers on the transmitter and receiver circuits (109, 107) provide and control the communication link between both circuits.

FIG. 3 further shows the VLC receiver (107) includes a photodiode (105) and a modified Fresnel lens (103) curved into a convex shape such that multiple focal points (110) are created when light from an LED (101) is diffracted through the lens (103) to the photodiode (105), allowing the light signal to be received by the photodiode (105) at the different positions of the photodiode (105) corresponding to said focal points (110). The photodiode (105) may be positionable at multiple focal points (110) to receive the incoming light signal. This improves the field of view (FOV) of detection of the VLC receiver (100). However, it is to be appreciated that the photodiode (105) is typically positioned such that the received power is the highest at an incident plane with the photodiode (105) which would be the optimal position for the photodiode (105). The LED (101) used is a standard commercial LED and a silicon PIN photodiode is used for its high sensitivity. The light source used may further be selected from Laser Diode, Laser, Spatial Light Modulator (SLM) with a backlight or any modulated light source. The photodetector used may be selected from a photodiode, array of photodiodes, charge-coupled device (CCD) array, CMOS array, avalanche photodiode (APD) and array of APD detectors that allow detection of high bandwidth optical signals.

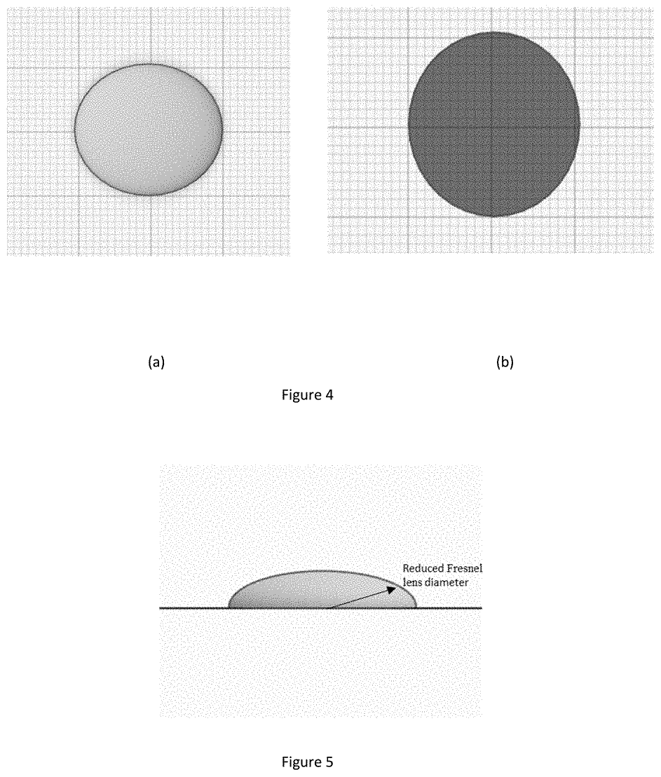

In order to improve the performance of a VLC system described above, a Fresnel lens (103) is used to improve field of view of a receiver (100). FIG. 4(a) shows a top view of the modified Fresnel lens (103) and FIG. 4(b) shows a bottom view of the modified Fresnel lens (103). FIG. 5 shows a front view of the modified lens (103) which has a reduced lens diameter.

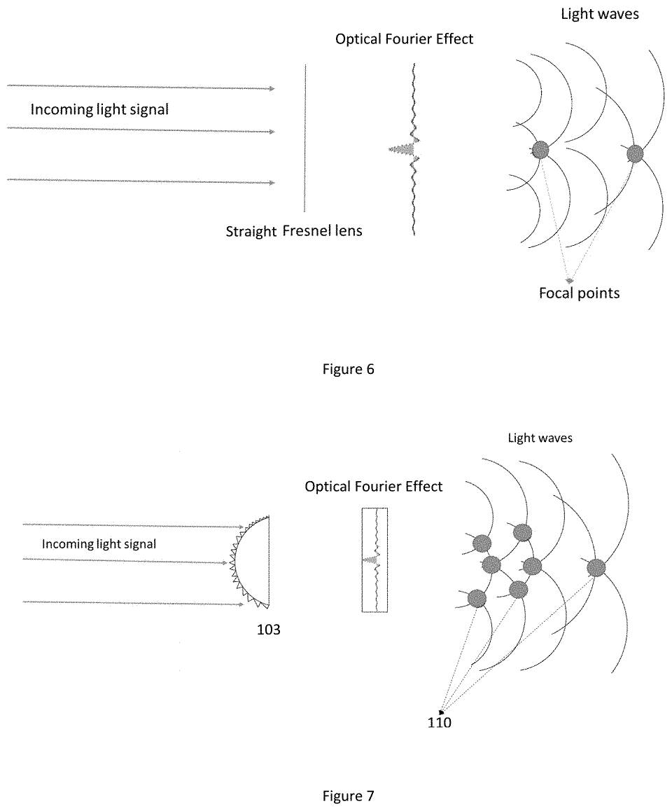

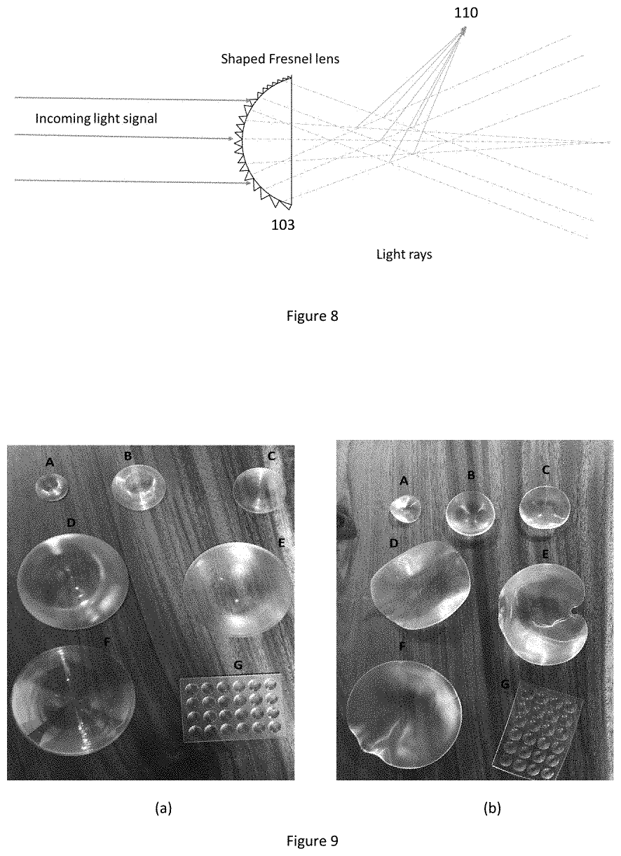

FIGS. 6 and 7 show a difference in the effect that a Fresnel lens (103) has on light signals that pass through. FIG. 6 shows a known Fresnel lens that is used to pass light signals through which results in a minimal number of focal points generated. When a straight Fresnel lens receives an incoming light signal, the lens converges the incoming parallel rays of light at one point which is called principal focus as shown in FIG. 6. FIG. 7 shows a Fresnel lens (103) that has been modified by bending the lens. Due to the reduced diameter of the lens from the modification as a result of shaping the lens, the incoming parallel rays of light will converge in a random manner producing multiple focal points (110) at various different positions due to the intersecting light rays (as seen in FIG. 8), which is different from known usage of Fresnel lenses that produce fewer focal points. This optical Fourier effect enhances signal quality by providing multiple focal points (110) from various wavefronts that propagate over the lens (103). The advantage of using a modified lens is that the photodiode (105) can be placed at different locations if necessary in order to increase the angles of transmission of light in the system as well as at varying distance between LED (101) and photodiode (101). This can be seen in experiments conducted that will be described below.

The Fresnel lenses are modified by heating up the lens in a container such as a bowl to retain a specific diameter in accordance to a selected bowl or container size. The lens to be modified is placed in a large soft bowl with preheated cooking oil at around 80° C. to 90° C. to be heated up for 3 to 5 minutes. The heated lenses are then placed in bowls with different diameters in order to produce the different sizes of lenses. Pressure may be applied when the lenses are placed in the bowl to mould the lenses to the desired shape. The shaping is done within 10 to 12 seconds after heating to ensure the lens is still soft. Finally, the lens is cooled down by placing the lens in a bowl of water at room temperature. It is to be appreciated that the Fresnel lenses may be shaped by heating, deposition methods, or other mechanical means or a combination of both as needed.

TABLE 1

| | Number of | Diameter | Focal length | Thickness |
|---|---|---|---|---|
| Index | lenses | (mm) | (mm) | (mm) |
| A | 1 | 30 | 16 | 2 |
| B | 1 | 50 | 28 | 2 |
| C | 1 | 50 | 40 | 2 |
| D | 1 | 100 | 70 | 2 |
| E | 1 | 110 | 60 | 2 |
| F | 1 | 110 | 70 | 2 |
| G | 17 | 12 | 12 | 2 |

Table 1 below shows 7 different types of Fresnel lenses that have been used in the following experiments as seen in FIG. 9(a) before lens modification and (b) after lens modification.

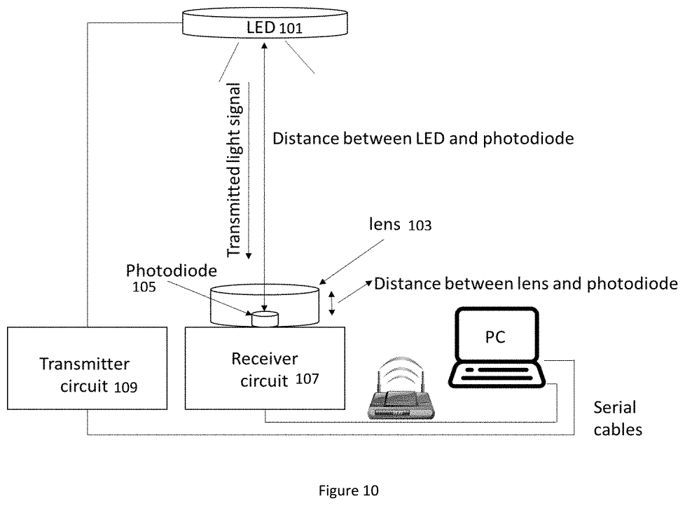

FIG. 10 shows an experimental set up of the optical VLC receiver (100) where a photodiode (105) is placed directly within line of sight of the LED (101) (at 0° angle between LED (101) and photodiode (105)). The modified Fresnel lens (103) is placed before the photodiode (105) within the same line of sight. The photodiode (105) is further connected to a receiver circuit (107). A transmitter and receiver circuit (109, 107) is further connected to a computer to generate signals and process received signals. The experiment is conducted by varying the distance between the LED (101) and the photodiode (105) between 30 cm to 285 cm. Multiple files of various file sizes are sent from the LED (101) to the receiver circuit (107) in order to determine lens performance.

Table 2 shows the results of the experiment where lens B and C are the modified Fresnel lenses (103) with the highest efficiency.

TABLE 2
Overall lens efficiency at 0° (at distance
range of 30 cm to 285 cm)

| Lens | VLC Efficiency % |
|---|---|
| No Lens | 13.70% |
| Lens A | 62.47% |
| Lens B | 94.08% |
| Lens C | 98.96% |
| Lens D | 53.83% |
| Lens E | 50.00% |
| Lens F | 50.00% |
| Lens G | 48.79% |

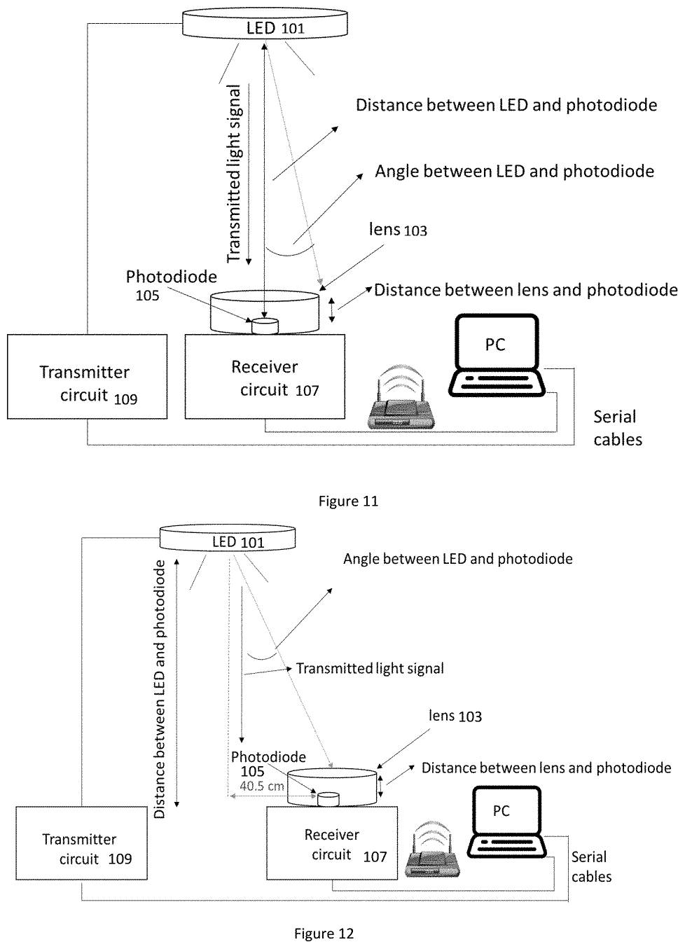

FIG. 11 shows a similar experimental set up of the optical VLC receiver (100) where a photodiode (105) is placed directly within line of sight of the LED (101). However, in this set up, the angle between the LED (101) and photodiode (105) is varied from 10° and with intervals of 10° up to 100° for the purpose of this experiment. The LED (101) is moved manually in order to get the required angle between the LED (101) and photodiode (105). Multiple files of various file sizes are sent from the LED (101) to the receiver circuit (107) in order to determine lens performance.

TABLE 3
Lens efficiency with varying transition
angle at 75 cm fixed distance

| Lens | Total VLC Efficiency |
|---|---|
| No Lens | 0.00% |
| Lens A | 82.19% |
| Lens B | 92.86% |
| Lens C | 89.46% |
| Lens D | 86.60% |
| Lens E | 80.00% |
| Lens F | 85.89% |
| Lens G | 70.26% |

Table 3 shows the results of the experiment where lens B and C are the modified Fresnel lenses (103) with the highest efficiency.

FIG. 12 shows a similar experimental set up of the optical VLC receiver (100) where a photodiode (105) is placed at specific distance off the line of sight of the LED (101) such that the angle between the LED (101) and photodiode (105) is varied from 10° and with intervals of 10° up to 100°. An example of the specific distance used is 40.5 cm. The experiment is conducted at a fixed distance of 30 cm between the LED (101) and the photodiode (103). Multiple files of various file sizes are sent from the LED (101) to the receiver circuit (107) in order to determine lens performance.

TABLE 4
Lens efficiency at 30 cm and
varied photodiode position

| lens | Total VLC Efficiency |
|---|---|
| No Lens | 61.09% |
| Lens A | 100.00% |
| Lens B | 100.00% |
| Lens C | 100.00% |
| Lens D | 100.00% |
| Lens E | 100.00% |
| Lens F | 100.00% |
| Lens G | 98.51% |

Table 4 shows the results of the experiment where almost all of the lenses show a high efficiency.

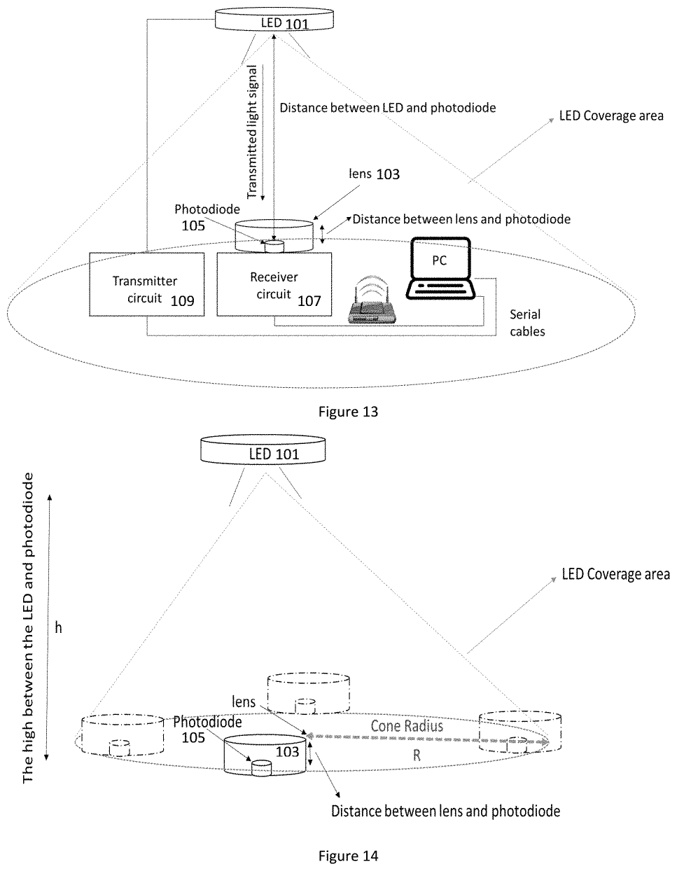

FIG. 13 shows an experimental set up of the optical VLC receiver (100) in order to determine coverage area of LED and field of view (FOV) of detection of the VLC receiver (100). The test has been carried out using three different fixed distances between LED (101) and photodiode (105) of 30 cm, 150 cm and 225 cm. The photodiode (105) and lens (103) are then moved around the LED coverage area with a cone radius, R as seen in FIG. 14. Multiple files with various file sizes are sent at various photodiode positions in order to determine lens performance.

Table 5 shows the results of the experiment using Lens B and C (which has had the best efficiency in the previous experiments). Lens B and C show the best maximum beam angle at the LED-photodiode distance of 150 cm as well as with a larger radius of 121 cm or 130 cm compared to when no lens is used. Therefore, the modified Fresnel lens (103) provides an improved field of view over other lenses or when no lenses are used.

TABLE 5
Coverage area with maximum beam angle test

| | | | Base | | Total | | |
|---|---|---|---|---|---|---|---|
| | | | surface | Volume | surface | | |
| | | | area of | of a | area of | max | max |
| | Height | Radius | a cone | cone | a cone | beam | beam |
| Lens | (cm) | (cm) | (m²) | (m.³) | (m²) | (Rad) | (degree) |
| No | 30 | 27 | 0.23 | 0.02 | 0.57 | 0.732 | 41.987 |
| Lens | | | | | | | |
| Lens | 150 | 121 | 4.60 | 2.30 | 11.93 | 0.678 | 38.891 |
| B | | | | | | | |
| Lens | 150 | 130 | 5.31 | 2.65 | 13.42 | 0.714 | 40.914 |
| C | | | | | | | |
| Lens | 225 | 90 | 2.54 | 1.91 | 9.40 | 0.380 | 21.801 |
| B | | | | | | | |
| Lens | 225 | 115 | 4.15 | 3.12 | 13.28 | 0.472 | 27.072 |
| C | | | | | | | |

The experiments conducted above show an overall lens performance summary as seen below in Table 6.

TABLE 6
Overall lens performance summary

| Rank | Lens | Overall VLC Efficiency % |
|---|---|---|
| 1 | B | 94.431% |
| 2 | C | 89.530% |
| 3 | A | 81.280% |
| 4 | F | 77.782% |
| 5 | D | 72.609% |
| 6 | E | 70.059% |
| 7 | G | 61.843% |
| 8 | No Lens | 33.292% |

As seen in Table 6, lens B and lens C shows the highest efficiency in a VLC receiver (100) based on the experimental results. Table 7 and Table 8 provide the performance summary of the two most efficient lenses in the VLC receiver (100).

TABLE 7
Lens B performance summary

| Parameter | Value |
|---|---|
| Maximum distance (cm) | 285 |
| Maximum FOV | 38.89° at 225 cm |
| Lens | B |
| Overall VLC efficiency % | 94.432% |

TABLE 8
Lens C performance summary

| Parameter | Value |
|---|---|
| Maximum distance (cm) | 285 |
| Maximum FOV | 40.91° at 225 cm |
| Lens | C |
| Overall VLC efficacy % | 89.530% |

Results of the experiments above show that the modified Fresnel lens (103) were shaped with the resulting characteristics as seen in Table 9 below.

TABLE 9

| | | | LOS (degree) at | |
|---|---|---|---|---|
| | Average | Number | 75 cm distance | |
| | focal | of focal | between Tx and | Height |
| Lens | length | points | Rx | (cm) |
| Lens A | 2.0- 2.5 cm | 1 | 90 | 200 |
| Lens B | 6.3-6.6 cm | 3 | 93 | 285 |
| Lens C | 4.2-4.6 cm | 2 | 90 | 285 |
| Lens D | 6.4-6.7 cm | 2 | 90 | 150 |
| Lens E | 6.3-7.0 cm | 2 | 80 | 150 |
| Lens F | 4.2-4.7 cm | 1 | 90 | 150 |
| Lens G | 2.2-2.4 cm | 17 | 70 | 150 |

The modified Fresnel lens (103) is used in a hybrid VLC system wherein Li-Fi is used to transmit downlink data and WiFi is used to transmit uplink data. The default path for data transmission is the Li-Fi link and when this link is blocked or hindered, the hybrid system automatically switches to use WiFi instead. The microcontroller modulates and demodulates the data, processes the data to be transmitted or received over LiFi. The option of hybrid VLC system provides improved security over pure WiFi systems as personal data is not easily accessed. The hybrid VLC also provides wider bandwidth capabilities as well as a higher immunity to Electromagnetic Interference (EMI) over existing WiFi systems. Usage of the modified Fresnel lens (103) in the hybrid VLC system enables the system to compensate for LOS and out of range interference.

It will be appreciated by the person skilled in the art that the VLC receiver (100) using the modified Fresnel lens (103) in the present invention improves the efficiency of the VLC and improves the field of view of the receiver coverage. The improved Fresnel lens (103) is able to enhance the received power of the VLC receiver (100) by placing the photodiode (105) under multiple focal points (110). The usage of the modified Fresnel lens (103) also improves the transmission distance between the LED (101) to the photodiode (105). It is further to be understood that the modified Fresnel lens (103) may be used bi-directionally, i.e. both sides of the modified Fresnel lens (103) to provide multi focal points in a VLC receiver (100).

1. A visible light communication (VLC) optical receiver (100), the receiver (100) includes;
a photodetector; and a modified Fresnel lens (103);
characterised in that the lens (103) is curved into a convex shape such that multiple focal points (110) are created when light from a light source is diffracted through the lens (103) allowing the light signal to be received by the photodetector at the different positions of the photodetector corresponding to said focal points (110).

2. The VLC receiver (100) as claimed in claim 1, wherein the Fresnel lens (103) has a decreased focal length and diameter to enhance receiver power.

3. The VLC receiver (100) as claimed in claim 1, wherein the photodetector may be positioned such that the received power is optimally the highest at an incident plane with the photodetector.

4. The VLC receiver (100) as claimed in claim 1, wherein the light source used is an LED (101) and the photodetector used is a photodiode (105).

5. The VLC receiver (100) as claimed in claim 1, wherein the photodetector is a photodiode array (105).

6. The VLC receiver (100) as claimed in claim 1, wherein efficiency of the received power is increased up to a relatively longer distance between an LED (101) and the photodiode (105) compared to efficiency of an unmodified lens.

7. The VLC receiver (100) as claimed in claim 1, wherein efficiency of the received power is increased up to a relatively wider angle between an LED (101) and the photodiode (105) compared to efficiency of an unmodified lens.

8. The VLC receiver (100) as claimed in claim 1, wherein the receiver (100) is used in a hybrid VLC system where data is transmitted or received over WiFi or LiFi.

9. A modified Fresnel lens (103) used within a VLC receiver (100), according to claim 1 any of the preceding claims.

10. A The modified Fresnel lens (103) used within a VLC receiver as claimed in claim 7, wherein the lens (103) is shaped by heating up the lens (103) in accordance to a selected container size.

11. A The modified Fresnel lens (103) used within a VLC receiver as claimed in claim 7, wherein the lens (103) provides an improved field of view for a VLC receiver (100) over other lenses or when no lenses are used.

12. A The modified Fresnel lens (103) used within a VLC receiver as claimed in claim 7, wherein the modified Fresnel lens (103) may be used bidirectionally, to provide multi focal points (110) in a VLC receiver (100).

13. A The modified Fresnel lens (103) used within a VLC receiver as claimed in claim 7, wherein the modified Fresnel lens (103) is used in a hybrid VLC system where data is transmitted or received over WiFi or LiFi.
